(19) United States
(12) Patent Application Publication
(10) Pub. No.: US 2009/0199730 A1
(43) Pub. Date: Aug. 13, 2009

(54) APPARATUS AND METHOD FOR DRIVING A PRINTING PRESS

(75) Inventor: Shinichiro Senoo, Mihara-shi (JP)

Correspondence Address: KANESAKA BERNER AND PARTNERS LLP, 1700 DIAGONAL RD, SUITE 310, ALEXANDRIA, VA, 22314-2848, US

(73) Assignee: Mitsubishi Heavy Industries, Ltd., Tokyo (JP)

(21) Appl. No.: 12/375,270

(22) PCT Filed: Sep. 21, 2007
(86) PCT No.: PCT/JP2007/068437

§ 371 Date: Feb. 24, 2009

(30) Foreign Application Priority Data
Sep. 22, 2006 (JP) 2006-257623

(51) Int. Cl. B41L 25/00

(52) U.S. Cl. 101/148

(57) ABSTRACT

An apparatus and method for driving a printing press, which are capable of easily and properly performing a water process on a processless plate so that the labor of an operator can be lessened, and also capable of printing that employs the processless plate in order to suppress an increase in the make ready time of the printing press itself and an increase in waste paper due to the water process. The apparatus includes plate determining means for determining whether a printing plate placed on a plate cylinder (31b to 34b) of a printing unit by plate exchange is the processless plate. The apparatus further includes control means 9 which, if the printing plate is determined to be the processless plate by the plate determining means, performs control so that the plate cylinder (31b to 34b) is rotated at a preset speed without actual contact with printing paper and also the water process is performed only for a preset period of time.

### CROSS-REFERENCE TO RELATED APPLICATIONS

The present Application is based on International Application No. PCT/JP2007/68437, filed on Sep. 21, 2007, which in turn corresponds to Japanese Application No. 2006-257623 filed on Sep. 22, 2006, and priority is hereby claimed under 35 USC § 119 based on these applications. Each of these applications are hereby incorporated by reference in their entirety into the present application.

### TECHNICAL FIELD

The present invention relates to an apparatus and method for driving a printing press capable of printing with a processless plate.

### BACKGROUND ART

In lithographic presses, such as sheet-fed offset printing presses, commercial web offset presses, and newspaper web offset presses, CTP (computer to plate that outputs a printing plate (PS plate: pre-sensitized plate) directly from data is coming into use. In CTP, CTP plates have hitherto been subjected to drawing using a laser, development, and gumming processes.

At present, in CTP, with the advent of processless plates (processless CTP plates), printing plates in which a development process is unnecessary in the platemaking process are being used. As development of the processless plates is not performed in the platemaking process, they have various advantages, such as space saving of developers in a platemaking process (such as storage, control, and disposal of chemicals), less environmental damage than conventional printing plates, and so forth.

In a method of making the processless plate, a planographic plate material is first exposed. Then, with the exposed planographic plate material placed on a plate cylinder of a printing press, by applying ink for printing alone or ink and dampening solution (water) to the plate surface, unnecessary parts for printing are removed from the exposed surface, whereby development is performed. By way of example, patent document 1 discloses a technique for performing development by applying dampening solution to the plate surface of a printing plate (water process). In addition, as a technique for shortening the developing time on the plate cylinder of the processless plate, patent document 2 discloses a technique in which the supply of dampening solution and ink in a water process is carried out at optimum timing.

Patent Document 1: Japanese patent No. 2938397

Patent Document 2: Japanese patent laid-open publication No. 2000-52634

### DISCLOSURE OF THE INVENTION

### Problems to be Solved by the Invention

Generally, in the printing press, when printing is finished, the printing plate is exchanged for another printing plate for the next printing job to start printing, but when using the processless plate, water processing has to be carried out. That is, after the processless plate is placed on the plate cylinder, the printing press has to be driven idle. Then, the dampener is driven, and with the water feed roller in contact with the processless plate, dampening solution is applied to the surface of the processless plate for a fixed time to develop the plate surface. Because of this, an operator must perform the sequence of operations sequentially, so that the labor of the operator is greatly increased.

In the case where such water processing (applying dampening solution to the plate surface of a printing plate) is manually performed on the processless plate, the processing will depend to some degree upon the sensibility of the operator, so there is a possibility that incomplete water processing, a difference in a printing plate of each color, and stains and printing defects at the start of printing will occur.

There is another possibility that ink will adhere to the printing plates because of forgetting of adjustments to the amount of dampening solution or insufficient adjustments and thereafter the adhesion will make the printing plates unusable.

On the other hand, in the water process, the printing press is caused to idle. Because of this, a web of paper (web continuous paper) put on the printing press is discharged by operation of the printing press and results in waste paper (broken). In the case of the printing press, make ready time, for example, for a rise in the temperature of a dryer is necessary as make ready for printing, and during the make ready time, waste paper also occurs. Since the processing time in the water process is added to the printing make ready time, an increase in the make ready time of the printing press itself due to this and an increase in waste paper due to water processing have become serious problems.

Note that web is considered to be cut off once to prevent waste paper. However, in this case, it is necessary to join the separated parts again and discharge the joined part at low speed to prevent paper jamming at a folder etc. Although waste paper can be reduced, the make ready time will be significantly increased and thus productivity will be reduced.

The present invention has been made in view of the circumstances described above. Accordingly, it is an object of the present invention to provide an apparatus and method for driving a printing press, which are capable of easily and properly performing a water process on a processless plate so that the labor of an operator can be lessened, and an increase in the make ready time of the printing press itself and an increase in waste paper due to the water process can also be suppressed.

### Means for Solving the Problems

To achieve the above object and in accordance with the present invention, there is provided an apparatus for driving a printing press capable of printing with a processless plate on which development is performed by a water process in which water is supplied to a plate surface on a plate cylinder. The apparatus includes: (1) plate determining means for determining whether a printing plate placed on the plate cylinder of a printing unit by plate exchange is the processless plate; and (2) control means which, if the printing plate is determined to be the processless plate by the plate determining means, performs control so that the plate cylinder is rotated at a preset speed without actual contact with printing paper, and also the water process is performed only for a preset period of time.

In the water process described above, when the apparatus is equipped with water feed rollers for supplying dampening solution to the printing plates, the water feed rollers are brought into contact with the plate cylinders. When the apparatus is equipped with water sprayers for supplying water to the printing plates, they may be used for spraying water to the plate cylinders.

The apparatus may further include water temperature adjustment means for adjusting temperature of the water that is supplied to the printing plate.

In the printing-press driving apparatus described above, the water temperature adjustment means is preferably controlled in the water process so that the water temperature reaches a preset proper temperature.

In the printing-press driving apparatus described above, a dedicated function for the processless plate may be provided beforehand for at least any one of API, ink speed following, and water fountain roller speed following functions relating to control of the printing unit. The control means, on determining the printing plate to be the processless plate by the plate determining means, preferably controls the printing unit using the dedicated function.

In the printing-press driving apparatus described above, the control means preferably starts other processes related to printing make ready after carrying out the water process.

Alternatively, the control means may carry out the water process in parallel with other processes related to printing make ready.

In the printing-press driving apparatus described above, the other processes preferably include any of dryer temperature raising, preliminary ink supply, and impression or blanket cylinder cleaning processes.

In this case, the printing paper is continuous paper in the form of ribbon. When the dry temperature raising process is carried out in parallel with the water process, the control means preferably completes the water process at the time or before the dry temperature raising process is completed.

In accordance with the present invention, there is provided a method of driving a printing press capable of printing with a processless plate on which development is performed by a water process in which dampening solution (water) is supplied to a plate surface on a plate cylinder. The method includes a plate determining step of determining whether a printing plate placed on the plate cylinder of a printing unit by plate exchange is the processless plate; and a control step which, if the printing plate is determined to be the processless plate by the plate determining step, performs control so that the plate cylinder is rotated at a preset speed without actual contact with printing paper, and also the water process is performed only for a preset period of time.

In the printing-press driving method described above, the water temperature adjustment step preferably adjusts temperature of dampening solution that is supplied to the printing plate in the water process to a preset proper temperature.

In this case, a dedicated function for the processless plate may be provided beforehand for at least any one of API, ink speed following, and water fountain roller speed following functions relating to control of the printing unit. The control step, on determining the printing plate to be the processless plate by the plate determining step, preferably controls the printing unit using the dedicated function.

In the printing-press driving method described above, the control step preferably starts other processes related to printing make ready after carrying out the water process.

In this case, the control step preferably carries out the water process in parallel with other processes related to printing make ready.

In this case, the other processes may include any of dryer temperature raising, preliminary ink supply, and impression or blanket cylinder cleaning processes.

In the printing-press driving method described above, the printing paper is continuous paper in the form of ribbon. In this case, when the dry temperature raising process as another process of the printing make ready is carried out in parallel with the water process, the control step may complete the water process at the time or before the dry temperature raising process is completed.

### ADVANTAGES OF THE INVENTION

According to the printing-press driving apparatus and method of the present invention, if the printing plate is determined to be the processless plate at the time of plate exchange, the plate cylinder is rotated at a preset speed without actual contact with printing paper, and also the water process is performed only for a preset period of time. Therefore, the labor of operators required for water processing is greatly lessened, and water processing itself can be performed properly (neither too much nor too little). This makes it possible to minimize the time of water processing that is added to the make ready time for printing, whereby an increase in the make ready time resulting from water processing and an increase in waste paper associated with this can be suppressed.

If the temperature of dampening solution that is supplied to the printing plate in the water process is adjusted to a preset proper temperature, the water process can be quickly performed. For instance, if the temperature of dampening solution in the water process is higher than the normal temperature, development efficiency is good and therefore the water process can be quickly finished.

In the case of the printing plate being the processless plate, the printing units are controlled employing the dedicated functions for the processless plate (API, ink speed following, and water fountain roller speed following functions), so printing by the processless plate can be properly performed.

In addition, if other processes of the printing make ready (e.g., dryer temperature raising, preliminary ink supply, and impression or blanket cylinder cleaning processes) are started after the water process is finished, the water process is separated from the other processes. For example, the same processes as the printing make ready in the case of printing that employs normal printing plates without requiring the water process may be carried out after the water process, and therefore each process can be easily and properly performed.

In addition, if the other processes of the printing make ready (e.g., dryer temperature raising, preliminary ink supply, and impression or blanket cylinder cleaning processes) are carried out in parallel with the water process, the time required for the printing make ready can be shortened.

Furthermore, if the water process is completed when dryer temperature rise is completed, printing can be started at the same time when the dryer temperature rise is completed. Therefore, during water processing and dryer temperature rise, continuous paper in the form of a ribbon is caused to travel at low speed in order to suppress the occurrence of waste paper, and after dryer temperature rise, printing can be performed by quickly accelerating the continuous paper to printing speed, so that cutting-off of paper can be avoided which occurs by excessive drying of continuous paper by the dryer after the dryer temperature rise. That is, if water processing is not completed even after dryer temperature rise, continuous paper is caused to travel through the high-temperature dryer at low speed from the viewpoint of suppressing the occurrence of waste paper until water processing is completed after dryer temperature rise. As a result, if continuous paper passes through the high-temperature dryer at low speed, the paper will be excessively dried with the dryer and thus the possibility of paper being cut off will occur. However, since continuous paper can be quickly accelerated to printing speed after dryer temperature rise, such a possibility can be avoided.

### BRIEF DESCRIPTION OF THE DRAWINGS

FIG. 1 is a configuration diagram showing a printing press and a driving apparatus for the printing press in accordance with a preferred embodiment of the present invention;

FIG. 2 is a flowchart used to explain how plate exchange is performed according to plate classification by the printing-press driving apparatus and method of the preferred embodiment;

FIG. 3 is a flowchart used to explain how a water process is performed according to plate classification by the printing-press driving apparatus and method of the preferred embodiment;

FIGS. 4(a) and 4(b) are flowcharts used to explain examples of a process that is performed during plate exchange in accordance with the printing-press driving apparatus and method of the preferred embodiment, FIG. 4(a) showing a first example and FIG. 4(b) a second example;

FIGS. 5(a) and 5(b) are flowcharts used to explain examples of a printing make ready process that is performed during plate exchange in accordance with the printing-press driving apparatus and method of the preferred embodiment, FIG. 5(a) showing a first example and FIG. 5(b) a second example;

FIGS. 6(a), 6(b), and 6(c) are graphs used to explain an advantage of speed control that is obtained in accordance with the printing-press driving apparatus and method of the preferred embodiment, FIG. 6(a) showing the preferred embodiment and FIGS. 6(b) and 6(c) comparative examples; and

FIG. 7 is a time chart used to explain an example of a printing make ready process that is performed in accordance with the printing-press driving apparatus and method of the preferred embodiment.

### DESCRIPTION OF REFERENCE NUMERALS

1 Paper feed section
2 Infeed section
2a, 31a to 34a, 5a, 6a, 7a Drive motor (shaftless motor)
3 Printing section
4 Dryer section (dryer)
5 Cooling section
6 Web pass section
7 Folding machine
8 Motor controller
9 Controller as control means (general controller)
10 Web Continuous paper as printing paper
10a Roll
11 Reel stand
12 Brake
31 to 34 Printing unit
31b to 34b Plate cylinder
31c to 34c Blanket cylinder

### BEST MODE FOR CARRYING OUT THE INVENTION

Embodiments of the present invention will hereinafter be described with reference to the drawings.

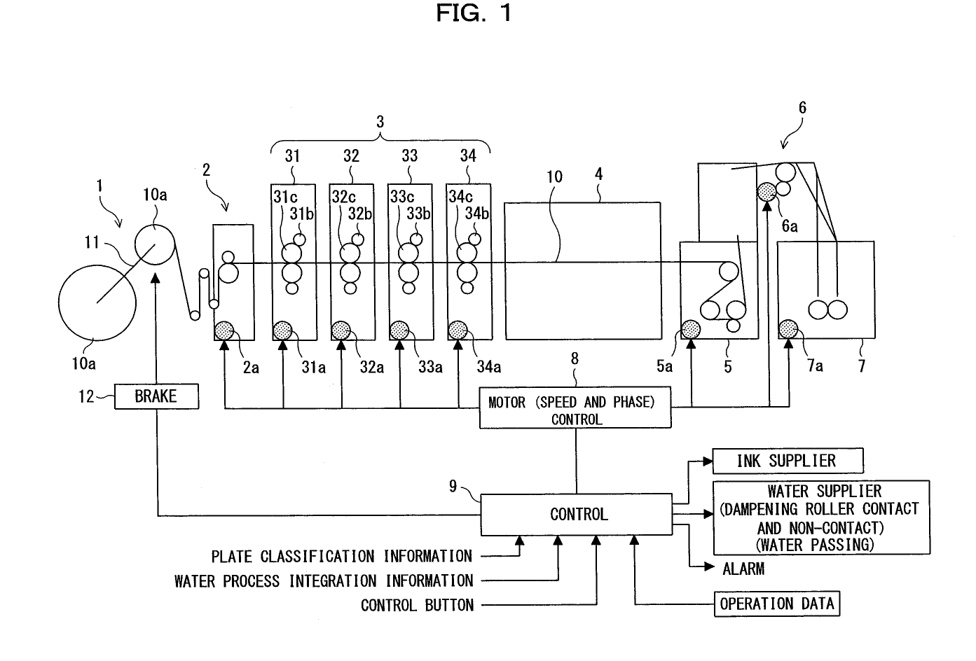

FIGS. 1 to 5 are used for explaining a printing press and an apparatus and method for driving the printing press, in accordance with a preferred embodiment of the present invention.

The printing press according to this embodiment, as shown in FIG. 1, is a commercial web offset press. The printing press, from its upstream side, is equipped with a paper feed section 1 having a reel stand 11 for supporting a role 10a of web (continuous paper in the form of a ribbon) 10 as printing paper; an infeed section 2 for sending out web 10 from the paper feed section 1; a printing section 3 with a plurality of printing units (e.g., four printing units) 31 to 34 for performing color printing on web 10 sent out from the infeed section 2; a dryer section (also referred to simply as a dryer) 4 for drying web 10 printed in the printing section 3; a cooling section 5 for cooling web 10 dried in the dryer section 4; a web pass section 6 for passing web 10 therethrough while adjusting its phase; and a folding machine 7 for performing cutting-off and folding operations on web 10 passed through the web pass section 6.

The infeed section 2, printing units 31 to 34, cooling section 5, web pass section 6, and folding machine 7 are equipped with drive motors (shaftless motors) 2a, 31a to 34a, 5a, 6a, and 7a so that each of the rotating parts can rotate independently of one another. The paper feed section 1 is equipped with a brake 12 for supplying friction to web 10 to slow it down or bring it to rest. The drive motors 2a, 31a to 34a, 5a, 6a, and 7a are controlled in speed and phase by a motor controller 8. The motor controller 8 and brake 12 are controlled by a controller (general controller) 9 as control means. Note that the controller 9 is constructed so as to control not only the motor controller 8 (drive motors 2a, 31a to 34a, 5a, 6a, and 7a) and brake 12 but also a variety of control elements of the printing press.

The printing units 31 to 34 are provided with upper plate cylinders 31b to 34b and blanket cylinders 31c to 34c for printing on the obverse side of web 10. Similarly, the printing units 31 to 34 are provided with lower plate cylinders 31b to 34b and blanket cylinders 31c to 34c for printing on the reverse side of web 10. (In FIG. 1, reference numerals for the lower plate cylinders 31b to 34b and blanket cylinders 31c to 34c are omitted.) By selecting either a normal plate [CTP plate made by conventional methods (in which film is burned onto a plate)] on which drawing, development, and gumming processes have been performed by a laser as CTP plate, or a processless plate (processless CTP plate), and placing the selected plate on each of the plate cylinders 31b to 34b, printing can be performed.

The controller 9 is adapted to receive plate classification information. When plate exchange is performed from the normal plate to the processless plate, the controller 9 is able to recognize the plate exchange from the plate classification information. For the plate classification information, for instance, a symbol (plate classification symbol) indicative of the processless plate is appended to the file name of higher image information, and by obtaining plate classification information from the file name information, it can be recognized from the plate classification information that plate exchange has been performed from the normal plate to the processless plate. Note that the higher image information is image information employing the original digital data that is to be burned onto a CTP plate. More specifically, the higher image information is obtained by processing the original digital image data (finally 1 bit of data) so that, like CIP ¾ data, resolution is divided into multiple levels.

To recognize that plate exchange has been performed to the processless plate, the printing press may include input means (plate classification selector switch) for selecting whether the printing plate put on the printing cylinder is the processless plate or not, and an operator may manipulate this input means to input plate classification information to the controller 9.

In printing, an auto preset inking system function (API function) indicating an ink supply quantity (in the case of an ink key system, an ink key opening) as a function of a printing area ratio (image area), a function of setting a peripheral speed ratio between the delivery roller and the ink source roller according to the speed of the printing press (ink speed following function), and a water fountain roller speed following function (function for setting a quantity of rotation of the water fountain roller according to the speed of the printing press to adjust a water quantity which is supplied to the plate surface of the printing plate and ink rollers), become necessary. These functions are set separately for each of the normal and processless plates.

In the case of the API function, it can be calculated by measuring, for example, image information drawn on a printing plate with an optical image area ratio meter, but even if the same image is measured by the optical image area ratio meter, the measured value varies depending upon the color of plate surface of a printing plate. If the normal plate is compared with the processless plate, they differ in the plate surface composition material of the image forming part of a printing plate and therefore they are generally different in plate surface color. Thus, even if the same image is read with an optical reader, the printing area ratio varies between the normal and processless plates. For that reason, different API functions have to be set separately for the normal and processless plates.

Similarly, for the setting of the ink speed following function and water fountain roller speed following function, different functions need to be set between the normal and processless plates from a difference in plate surface composition material. That is to say, the normal and processless plates are different in API function, depending on their properties, and are similarly different in printing property, so different ink speed following functions and water fountain roller speed following functions must be set separately for the normal and processless plates.

The functions that were set separately for the normal and processless plates have been input and stored in a data storage (not shown) in advance, along with other data related to other operations of the printing press. The controller 9 reads out these operation data (including the function data) from the data storage as needed, and uses them.

Therefore, if plate exchange is performed to the processless plate, the controller 9 recognizes from the input plate classification information that plate exchange has been performed from the normal plate to the processless plate, and reads out operation data (including each function data) corresponding to the processless plate, and uses them to drive the printing press.

When plate exchange is performed to the processless plate, it becomes necessary to perform a development process by a water process (applying dampening solution to the plate surface of a printing plate) before using the processless plate, so the water process is performed by supplying dampening solution to the plate surface of the processless plate with a dampener (water supplier) that is employed at the start of printing.

The controller 9, on recognizing that plate exchange has been performed from the normal plate to the processless plate, carries out the water process based on water processing conditions (a water supply quantity per unit time, plate cylinder speed, web speed, water processing time, and so forth) that have been input as preset operation data. That is, the printing cylinders (plate cylinders 31b to 34b and blanket cylinders 31c to 34c) are moved away from web 10 (the plate cylinders are out of contact with the blanket cylinders). In this state, while the printing cylinders (plate cylinders 31b to 34b and blanket cylinders 31c to 34c) are being rotated according to a preset speed schedule by controlling drive motors 31a to 34a, the water feed roller (or dampening roller, not shown) of the dampener is brought into contact with the plate surface of the processless plate to supply dampening solution to the plate surface. In this way, the development process is performed.

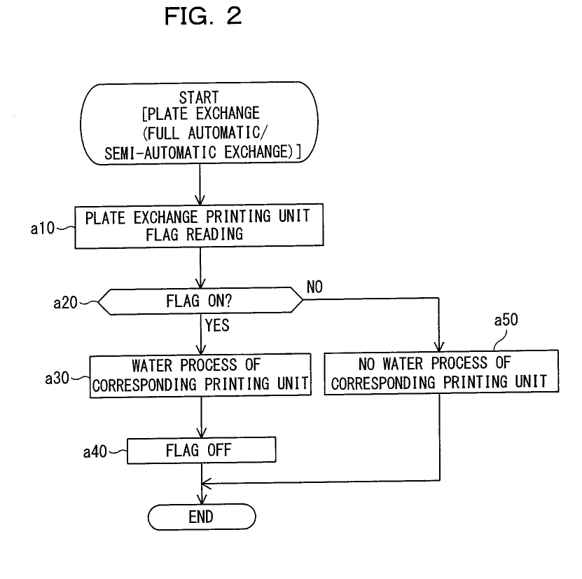

More specifically, in the controller 9, if plate exchange is performed, processing is performed as shown in FIG. 2. The plate exchanger in this case may be fully automatic or semi-automatic. Plate classification information about each of the printing units (called plate exchange printing flag information in this example) is first read into the controller 9 (step a10). The plate exchange printing flag is made ON if plate exchange is performed to the processless plate, and OFF if plate exchange is performed to the normal plate. It is then determined whether the plate exchange printing flag is ON or not (step a20). If it is ON, the water process is performed on the corresponding printing unit (step a30). After completion of the water process, the plate exchange printing flag is again made OFF (step a40). On the other hand, if it is OFF, no water process is performed on the corresponding printing unit (step a50).

The water process is stabilized by increasing a water supply quantity (dampening solution supply quantity) to be supplied in the water process more than a normal water quantity to be supplied during printing, and setting it at the maximum value of the water supply quantity per unit time that is supplied by the dampener, or at a predetermined value very close to the maximum value. The increase in the water supply quantity can be implemented by raising the rotation speed of a water fountain roller (not shown) that supplies dampening solution to the water feed roller. In this embodiment, mode switching is automatically performed in the water process by the controller 9 so that the water supply quantity can be increased. Of course, the switching may be manually made.

In addition, in the water process, the printing cylinders (plate cylinders 31b to 34b and blanket cylinders 31c to 34c) are operated at high speed to some degree [generally, the regulated speed to the printing speed of the printing press (e.g., 300 rpm to the maximum speed)], while web 10 is moved at slow speed much lower than the printing cylinders (e.g., a very slow speed at which paper is threaded into the printing press, or the minimum printing speed which exceeds the very slow speed) or is held in a stopped state. The reason the plate cylinders 31b to 34b are rotated at high speed to some degree is that if they are rotated at high speed to some degree, then a stable development process can be performed on the front surface of the printing plate, and consequently, the development of the entire printing plate can be quickly performed from the viewpoint of water process. On the other hand, the reason the speed of web 10 is reduced is that since web 10 in the water process results in waste paper, the speed of web 10 needs to be reduced from the viewpoint of minimizing waste paper.

However, if plate cylinders 31b to 34b are rotated excessively at high speed during the water process, transfer (adhesion) of water to the plate surface of the processless plate is reduced, and consequently, there is a possibility of the development process requiring more time. Considering this point, it is preferable to set the rotation speed of the plate cylinders 31b to 34b. That is, it is preferable to set the rotation speed so that the transfer of water to the plate surface is a predetermined level or greater. Note that for transfer of water, a water transfer quantity to the plate surface per unit time increases as the rotation speed of the plate cylinders 31b to 34b is increased from low speed, but after a certain rotation speed, the water transfer quantity is reduced as the rotation speed is increased. By grasping such a characteristic experimentally, a range of speeds can be obtained so that transfer of water is a predetermined level or greater. In this manner, the rotation speed can be set so that the transfer of water to the plate surface is a predetermined level or greater.

In addition, if the speed of web 10 is zero (stopped state), waste paper can be minimized, but if the speed of web 10 is reduced excessively or brought into a stopped state, water is concentratedly applied to a certain part of web 10 during the water process and therefore percolates into web 10 to greatly reduce the strength of web 10. As a result, if web 10 is started, there is a great possibility of web 10 being cut off. Hence, it is preferable to cause web 10 to travel at very slow speed to the degree that it is not cut off.

In this case, the cutting-off hardness (i.e., water resistance) of web 10 when water adheres to web 10 is varied according to the type of web 10 that is chosen. For instance, since coated paper is hard to be cut off (i.e., high in water resistance) even if water adheres, web 10 may travel at very low speed. On the other hand, because high-quality paper and bleached paper are easy to be cut off (i.e., low in water resistance) if water adheres, these papers need to travel at higher speed than coated paper to reduce the water quantity that adheres. It is preferable from the viewpoint of waste paper that web speed be as low as possible. Note that water resistance (degree of the cutting-off hardness of paper to a water adhesion quantity in total or per unit time) also varies according to the basis weight of paper.

Hence, it is preferable to set the speed of web 10 variable according to the type of web 10 so that the speed becomes as low as possible in a range without causing cutting-off of web 10 according to the water resistance.

The controller 9 causes the plate cylinders 31b to 34b to rotate at the speed of rotation thus set. When the plate cylinders 31b to 34b reach the set rotation speed after they are started, the water feed rollers are brought into contact with the processless plates. When a predetermined total quantity of water is applied to the plate surface of each processless plate, the water feed rollers are moved away from the processless plates, and the plate cylinders 31b to 34b are reduced in speed to a predetermined low speed or reduced in speed until they stop. Note that the total quantity of water is set in advance according to the state (e.g., area to be developed) of a plate surface by an operator etc., and is input to the controller 9.

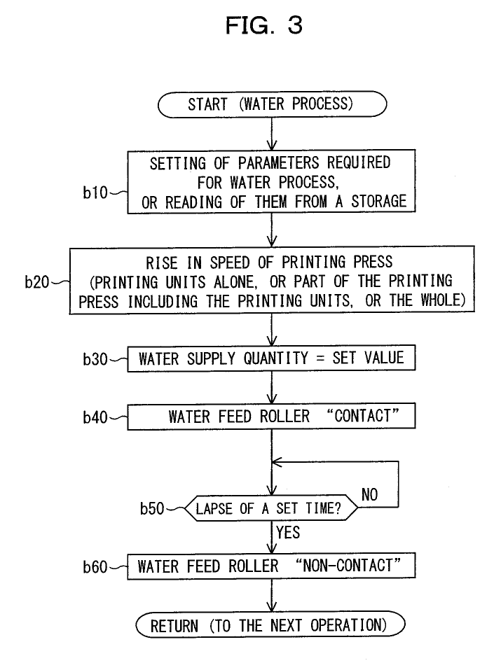

Therefore, the controller 9, as shown in FIG. 3, carries out water processing. That is, parameters required for water processing are set, or read out from the storage device (step b10). The parameters required for water processing are, for example, water-processing speed (speed of the printing units 31 to 34), the amount of time the water feed roller is held in contact with the plate cylinder, and water supply quantity (rotation quantity of the water fountain roller). Then, by raising the speed of the printing press (only the printing units, or part of the printing press including the printing units, or the whole part) (step b20), the water supply quantity is used as a set value (step b30). That is, the water fountain roller, for example, after being operated for 30 seconds at the minimum speed, is rotated at the maximum quantity of rotation (maximum speed of rotation). In the case of normal operation (printing), the rotation quantity of the water fountain roller is proportional to speed based on a certain function etc., but the water fountain roller speed at the time of water processing is set at a special value higher than the water fountain roller speed during normal operation. Then, the water feed roller is brought into contact with the plate cylinder (step b40) and held in contact with the plate cylinder until a set time elapses (step b50) so that water is applied. After the set time, the water feed roller is held out of contact with the plate cylinder, whereby the water processing is finished (step b60).

Furthermore, in this embodiment, the temperature of water that is supplied in the water process is adjusted to a preset proper temperature. This embodiment utilizes the water-passing structure of the water fountain roller to adjust the water temperature.

The water fountain roller has water-passing structure in the interior thereof so that it can be warmed or cooled by the temperature of water passed therethrough. In printing that originally employs the water-passing structure, since each part of the dampener is heated by the high-speed operation of each part of the printing press, water is passed through the water fountain roller to cool the roller, but since water processing is performed in starting the printing press, each part of the dampener is low in temperature during water processing and therefore dampening solution (water) itself is low in temperature.

On the other hand, in the case of performing development by water processing, if water to be supplied is raised to high temperature (proper temperature) to some degree, then development can be efficiently performed. Hence, warm water is passed through the water-passing structure of the water fountain roller to raise the temperature of the water fountain roller, whereby dampening solution is warmed to high temperature (proper temperature) to some degree by the water fountain roller. Thus, the water-passing structure of the water fountain roller functions as a means of adjusting the temperature of water to a preset proper temperature. If the temperature of water that is supplied is higher than the proper temperature, it can be reduced to the proper temperature by passing water through the water fountain roller.

The temperature adjustment means is not limited to the above example, but since this embodiment utilizes the existing water-passing structure, costs are not increased. In addition, since the temperature of dampening solution is adjusted immediately before it is supplied, the dampening solution temperature can be adjusted with good efficiency and good response, compared with the case where the temperature of dampening solution within a water tank is adjusted.

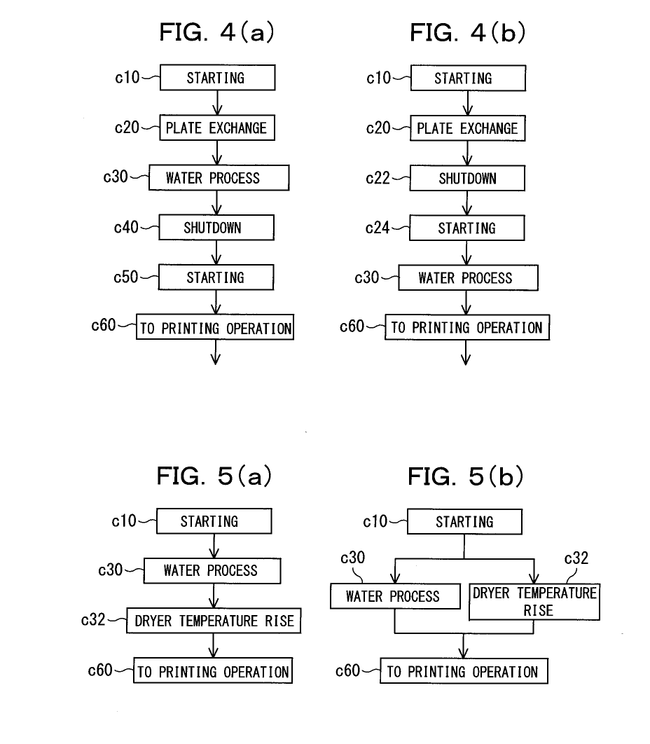

For such water processing, as shown in FIG. 4(a), after starting of the printing press (step c10) and completion of plate exchange (step c20), water processing (step c30) may be immediately performed without shutting down the printing press. As shown in FIG. 4(b), after starting of the printing press (step c10), then completion of plate exchange (step c20), then shutdown of the printing press (step c22), and restarting of the printing press (step c24), water processing (step c30) may be performed. As shown in FIG. 4(a), after water processing (step c30), shutdown of the printing press (step c40), and then restarting of the printing press (step c50), printing operation (step c60) may be started. Furthermore, as shown in FIG. 4(b), after water processing (step c30), printing operation (step c60) may be immediately started without shutting down the printing press.

Make ready for printing, in addition to the above-described water process, as with normal plates, are a dryer temperature raising process, a preliminary ink supply process, and an impression cylinder and/or blanket cylinder cleaning process. These processes other than the water process, as in the case of conventional printing, may be performed after the water process, or may be performed in parallel with the water process.

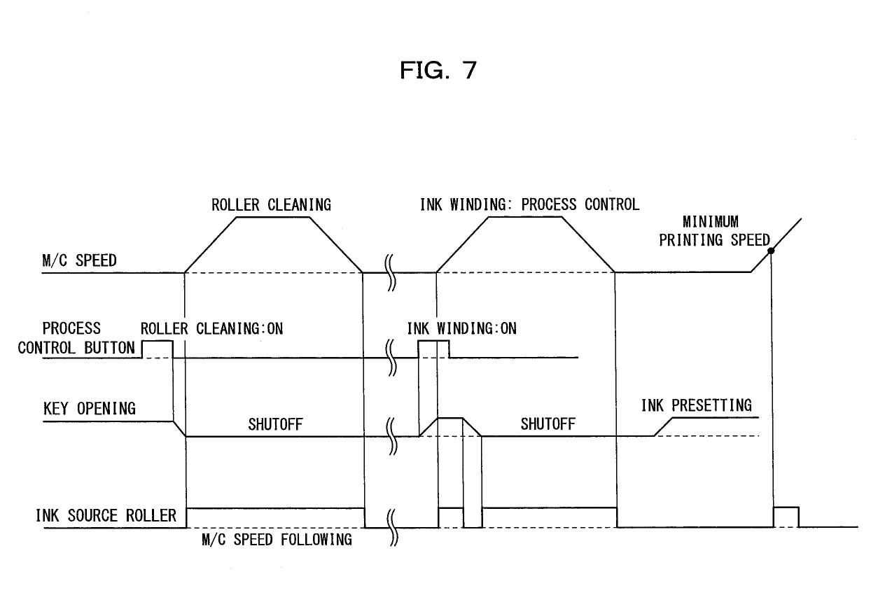

Printing make ready are shown in FIG. 7 by way of example. These manipulations are carried out as process control. The roller cleaning process is started by manipulation of a process control button for roller cleaning to increase the machine speed to a predetermined speed, and with the key opening made zero (no ink supply), the ink source roller is rotated. Thereafter, by manipulation of a process control button for ink winding (preliminary ink supply), an ink winding process is started to increase the machine speed to a predetermined speed, and with the key opening made zero (no ink supply) temporarily at the start of the process, the ink source roller is rotated as needed. In this case, the presetting of the ink key is then performed.

As the water process is performed only on parts that are dampened, it becomes possible to shorten the make ready time by performing the above-described preliminary supply of ink to parts to be inked (function of preliminarily supplying ink to ink rollers to raise printing density to a target density quickly) at the same time. In the case of sheet-fed offset printing presses, it is possible to perform the water process in parallel with the impression-cylinder cleaning process.

For example, directing attention to a dryer temperature raising process, as shown in FIG. 5(a), after starting of the printing press (step c10) and completion of the water process (step c30), the dryer temperature raising process (step c32) may be performed, or as shown in FIG. 5(b), after starting of the printing press (step c10), the dryer temperature raising process (step c32) may be performed in parallel with the water process (step c30).

The present invention is applicable to both cases shown in FIGS. 5(a) and 5(b), but in this embodiment, as shown in FIG. 5(b), the dryer temperature raising process is performed in parallel with the water process.

Particularly, in this embodiment, the timing at which the dryer temperature raising process is started is set according to the start timing of the water process so that the two processes are completed at the same time.

That is, as described above, in the case where web 10 is caused to travel at low speed from the viewpoint of suppressing the occurrence of waste paper, if the water process is not completed when the dryer temperature raising process is completed, until completion of the water process the web 10 is passed at low speed through the high-temperature dryer 4 in which a rise in temperature has been completed. If web 10 is passed through the high-temperature dryer 4 at low speed, web 10 will be excessively dried by the dryer 4 and the possibility of web 10 being cut off will occur.

If the dryer temperature raising process and water process are completed at the same time, web 10 can be accelerated to the printing speed quickly after completion of the dryer temperature raising process and thus such a possibility can be avoided. From the viewpoint of preventing excessive drying of web 10, even if the dryer temperature raising process and water process are not completed at the same time, it is well if the water process is completed before completion of the dryer temperature raising process. However, because it is considered that the time required for the water process will become longer than the time required for the dryer temperature raising process, it is preferable from the viewpoint of shortening the make ready time that the two processes be completed at the same time.

Furthermore, in this embodiment, considering substances that are dissolved in dampening solution in the water process, or the case where dust etc. produced in the water process are mixed with dampening solution, the controller 9 obtains water process integration information and, on determining from this information that water process history has reached a predetermined level, issues an alarm so that dampening solution exchange can be performed. An example of the water process integration information is an integrated value (number of sheets of paper) of the amount of web that travels in the water process. If the number of sheets of web that traveled in the water process reaches a predetermined value (hundreds of sheets of paper), an alarm is issued in order to indicate that dampening solution exchange is necessary. In the case of having a mechanism for automatically performing dampening solution exchange, the present invention may be constructed such that dampening solution exchange is automatically performed.

As the printing-press driving apparatus and method according to the preferred embodiment of the present invention are constructed as described above, the controller 9, at the time of plate exchange, based on plate classification information, determines from a flag signal whether the printing plate is the processless plate or not. If it is the processless plate, the plate cylinders 31b to 34b are rotated at a preset speed without actual contact with web 10, and with a water supplying state (water fountain roller speed) set at a predetermined value, the water process is performed only for a predetermined period of time with the water feed rollers brought into contact with the plate cylinders.

Therefore, the labor of operators required for water processing is greatly lessened, and water processing can be performed properly (neither too much nor too little). This makes it possible to minimize the time of water processing that is added to the make ready time for printing, whereby an increase in the make ready time resulting from water processing and an increase in waste paper associated with this can be suppressed.

Of course, there is no possibility that incomplete water processing, a difference in a printing plate of each color, and stains and printing defects at the start of printing, which occur easily when water processing for processless plates depends to a great extent upon the sensibility of an operator, will occur. In addition, there is no possibility that ink will adhere to the printing plates because of forgetting of adjustments to the amount of dampening solution or insufficient adjustments and thereafter the adhesion will make the printing plates unusable.

The temperature of dampening solution that is supplied to the printing plates is adjusted to a proper temperature at the time of water processing, so it becomes possible to perform water processing quickly. Particularly, the existing water-passing structure is used in the water fountain roller to adjust the temperature of dampening solution, so there is no increase in equipment costs. Furthermore, the temperature of dampening solution can be efficiently adjusted to a proper temperature, whereby water processing can be quickly completed.

In the case of the printing plate being the processless plate, if dedicated functions for the processless plate (API, ink speed following, and water fountain roller speed following functions) are used to control the printing units, printing by the processless plate can be appropriately performed.

In addition, since the water process is carried out in parallel with other processes of the printing make ready (e.g., dryer temperature raising, preliminary ink supply, and impression or blanket cylinder cleaning processes), the time required for the printing make ready can be shortened.

In the water process, the printing cylinders (plate cylinders 31b to 34b and blanket cylinders 31c to 34c) are operated at high speed to some extent, while web 10 travels at a speed much lower than the printing cylinders or is caused to be in a stopped state. From the viewpoint of water processing, a stable development process can be performed on the front surface of the printing plate if plate cylinders 31b to 34b are operated at high speed to some extent, so that development of the entire printing plate can be quickly performed. On the other hand, web 10 in the water process results in waste paper, so from the viewpoint of suppressing the occurrence of wastepaper, if the speed of web 10 is decreased, waste paper can be reduced.

If plate cylinders 31b to 34b are rotated excessively at high speed during water processing, there is a possibility of the development process requiring more time to the contrary, but since the speed of rotation of the plate cylinders 31b to 34b is set taking this point into account, the development process can be efficiently performed in a short time. Without making the speed of web 10 zero (stopped state), if web 10 is caused to travel at very slow speed to the degree that cutting-off of web 10 is not caused, waste paper can be minimized in a range not causing cutting-off of paper.

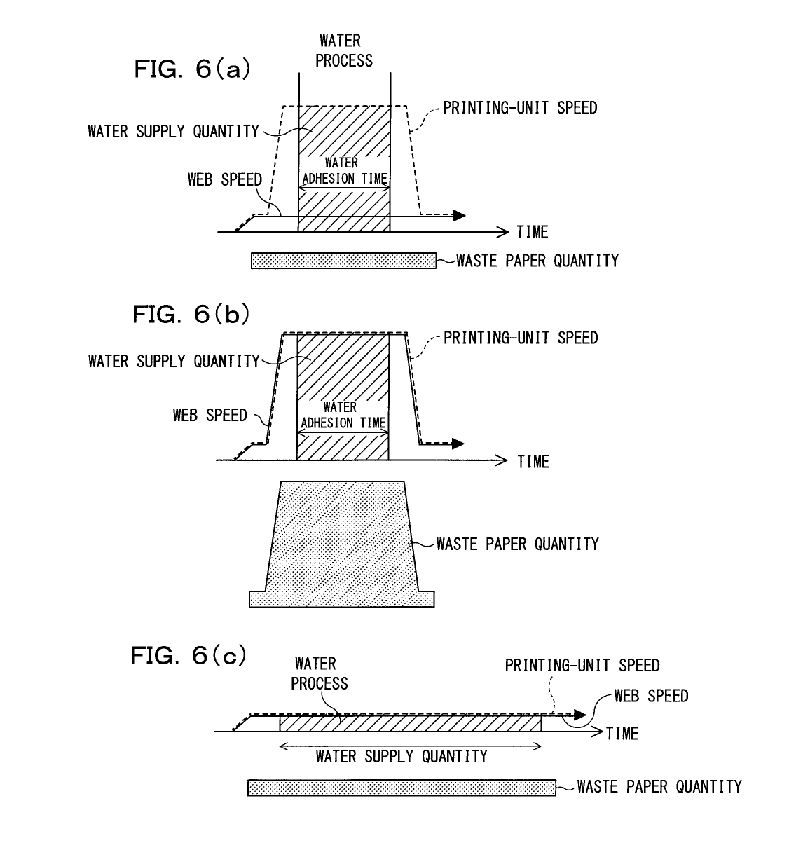

FIGS. 6(a) to 6(c) are timing diagrams showing printing-unit speed (speed of plate cylinders 31b to 34b) and web speed. FIG. 6(a) shows this embodiment, while FIGS. 6(b) and 6(c) show comparative examples. Note that a water supply quantity and waste paper quantity are indicated by areas, respectively. As shown in FIGS. 6(b) and 6(c), in the case where printing-unit speed (speed of printing cylinders 31b to 34b) and web speed are made equal to each other, if printing-unit speed is made high so that water processing can be performed with good efficiency (FIG. 6(b)), high-speed web travel causes a huge waste paper quantity, and if printing-unit speed is made low (FIG. 6(c)), water processing takes time and thus an increase in web travel time causes a huge waste paper quantity. By contrast, as shown in FIG. 6(a), if printing-unit speed (speed of printing cylinders 31b to 34b) is made high to some degree, and web speed is made much lower than the printing-unit speed in a range not causing cutting-off of web 10, water processing can be performed with better efficiency, and on top of that, a reduction in the travel speed and travel time of web can significantly reduce a waste paper quantity.

In addition, in this embodiment, the timing at which the dryer temperature raising process is started is set according to the start timing of the water process so that the two processes are completed at the same time. Therefore, since web 10 can be accelerated to printing speed soon after the dryer temperature raising process has bee completed, the possibility of paper being cut off by excessively drying the paper with the dryer after completion of the dryer temperature raising process can be avoided.

Even if the dryer temperature raising process and water process are not finished at the same time, the water process may be completed before completion of the dryer temperature raising process from the viewpoint of preventing excessive drying of web 10, but since it is considered that the time required for the water process will be longer than the time required for the dryer temperature raising process, the make ready time can be shortened if the water process is completed at the same time when the dryer temperature raising process is completed.

<OTHER> While the present invention has been described with reference to the preferred embodiment thereof, the invention is not to be limited to the details given herein, but may be modified within the scope of the invention hereinafter claimed.

For example, although it has been described that the above embodiment is equipped with water feed rollers for supplying dampening solution to the printing plates, it may be equipped with water sprayers for supplying dampening solution to the printing plates. In this case, water sprayers may be used for spraying water in the water process. That is, the present invention may use any type of dampening solution supply device to supply water to the printing plates.

In the above embodiment, while each operation in the water process is automatically performed by being controlled by the controller 9, some of the operations may be performed by operator's manipulation (e.g., manipulation of each control button).

In addition, while the above embodiment is applied to a commercial web offset press, the present invention is applicable to other printing presses such as sheet-fed offset printing presses, newspaper web offset presses, etc.

The present invention is widely applicable in employing processless plates, in a variety of printing presses, such as sheet-fed offset printing presses, commercial web offset presses, and newspaper web offset presses.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. An apparatus for driving a printing press capable of printing with a processless plate on which development is performed by a water process in which dampening solution is supplied to a plate surface on a plate cylinder, said apparatus comprising:
plate determining means for determining whether a printing plate placed on the plate cylinder of a printing unit by plate exchange is the processless plate; and
control means which, if said printing plate is determined to be the processless plate by said plate determining means, performs control so that said plate cylinder is rotated at a preset speed without actual contact with printing paper, and also said water process is performed only for a preset period of time.

2. The apparatus as set forth in claim 1, further comprising:
dampening solution temperature adjustment means for adjusting temperature of said dampening solution that is supplied to said printing plate;
wherein said dampening solution temperature adjustment means is controlled in the water process so that the dampening solution temperature reaches a preset proper temperature.

3. The apparatus as set forth in claim 1, wherein a dedicated function for said processless plate is provided beforehand for at least any one of API, ink speed following, and water fountain roller speed following functions relating to control of said printing unit, and said control means, on determining said printing plate to be the processless plate by said plate determining means, controls said printing unit using said dedicated function.

4. The apparatus as set forth in claim 1, wherein said control means starts other processes related to printing make ready after carrying out said water process.

5. The apparatus as set forth in claim 1, wherein said control means carries out said water process in parallel with other processes related to printing make ready.

6. The apparatus as set forth in claim 4, wherein said other processes include any of dryer temperature raising, preliminary ink supply, and impression or blanket cylinder cleaning processes.

7. The apparatus as set forth in claim 5, wherein said printing paper is continuous paper in the form of ribbon, and when the dry temperature raising process is carried out in parallel with said water process, said control means completes said water process at the time or before said dry temperature raising process is completed.

8. A method of driving a printing press capable of printing with a processless plate on which development is performed by a water process in which dampening solution is supplied to a plate surface on a plate cylinder, said method comprising:
a plate determining step of determining whether a printing plate placed on the plate cylinder of a printing unit by plate exchange is the processless plate; and
a control step which, if said printing plate is determined to be the processless plate by said plate determining step, performs control so that said plate cylinder is rotated at a preset speed without actual contact with printing paper, and also said water process is performed only for a preset period of time.

9. The method as set forth in claim 8, wherein said control step adjusts temperature of dampening solution that is supplied to said printing plate in said water process to a preset proper temperature.

10. The method as set forth in claim 8, wherein a dedicated function for said processless plate is provided beforehand for at least any one of API, ink speed following, and water fountain roller speed following functions relating to control of said printing unit, and said control step, on determining said printing plate to be the processless plate by said plate determining step, controls said printing unit using said dedicated function.

11. The method as set forth in claim 8, wherein said control step starts other processes related to printing make ready after carrying out said water process.

12. The method as set forth claim 8, wherein said control step carries out said water process in parallel with other processes related to printing make ready.

13. The method as set forth in claim 11, wherein said other processes include any of dryer temperature raising, preliminary ink supply, and impression or blanket washing processes.

14. The method as set forth in claim 12, wherein said printing paper is web, and when the dryer temperature raising process is carried out in parallel with said water process, said control step completes said water process at the time or before said dry temperature raising process is completed.

15. The apparatus as set forth in claim 2, wherein a dedicated function for said processless plate is provided beforehand for at least any one of API, ink speed following, and water fountain roller speed following functions relating to control of said printing unit, and said control means, on determining said printing plate to be the processless plate by said determining means, controls said printing unit using said dedicated function.

16. The apparatus as set forth in claim 3, wherein said control means starts other processes related to printing make ready after carrying out said water process.

17. The apparatus as set forth in claim 3, wherein said control means carries out said water process in parallel with other processes related to printing make ready.

18. The method as set forth in claim 9, wherein a dedicated function for said processless plate is provided beforehand for at least any one of API, ink speed following, and water fountain roller speed following functions relating to control of said printing unit, and said control step, on determining said printing plate to be the processless plate by said plate determining step, controls said printing unit using said dedicated function.

19. The method as set forth in claim 10, wherein said control step starts other processes related to printing make ready after carrying out said water process.

20. The method as set forth in claim 9, wherein said control step carries out said water process in parallel with other processes related to printing make ready.
